(19) United States
(12) Patent Application Publication
(10) Pub. No.: US 2009/0211058 A1
(43) Pub. Date: Aug. 27, 2009

(54) SYNTHETIC RESIN MEMBER HAVING A FEMALE SCREW

(75) Inventor: Yutaka NAGAYAMA, Kishiwada-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NAGAYAMA ELECTRIC CO., LTD., Osaka (JP)

(21) Appl. No.: 12/372,948

(22) Filed: Feb. 18, 2009

(30) Foreign Application Priority Data
Feb. 25, 2008 (JP) 2008-42703

(51) Int. Cl. A47J 45/08; F16M 11/24

(52) U.S. Cl. 16/446; 248/188.4

(57) ABSTRACT

There is provided a synthetic resin member, having a screw formation portion and synthetic resin body. The screw formation portion has: a cylindrical metal portion having a first end and a second end, a female screw part being formed on the cylindrical portion; a release prevention portion formed at the first end; a flange portion formed at the second end, the flange portion having a first surface and a second surface opposite to the first surface; and a rotation prevention portion formed on the first surface. The synthetic resin body has: a body portion perpendicularly extending to have a third end and a fourth end, the body portion having a screw engagement portion perpendicularly penetrating the body portion. The cylindrical metal portion is inserted into the screw engagement portion. The release prevention portion is caulked with the third end of the body portion. The rotation prevention portion is engaged with the synthetic resin body at or near the fourth end of the body portion.

### TECHNICAL FIELD

The present invention relates to a synthetic resin member having a female screw of a metal.

### BACKGROUND OF INVENTION

A nip for operating a valve is attached to an operating shaft of an open/close valve. There has been a nip made of a synthetic resin in view of light weight compared with a metal material. It is also advantageous in view of its heat insulating property.

On the other hand, an operating shaft of an open/close valve mostly includes a screw shaft made of a metal, to which the nip for valve opening operation is attached. The nip for valve operation has formed screw hole (female screw) which is engaged with the screw shaft.

When a metal screw hole is formed with a synthetic resin, a hexagonal nut of a metal is set on a molding while forming a synthetic resin. Then, the synthetic resin being molten at a high temperature is poured into the molding so as to form a resin product. The resin product has so-called poured nut structure. See Utility Model Patent Publication No. 5-633320.

However, in such a process, it is necessary to work in positioning the hexagonal nut in the metal molding. In addition, the hexagonal nut is heated at a relatively high temperature. Thus, it may cause burn injury by accidentally touching it. Also, the hexagonal nut may happen to position incorrectly.

Thus, the hexagonal nuts cannot be collected until they are sufficiently cooled down, thereby resulting in low productivity.

Moreover, since the synthetic resin insulates, the hexagonal nut mold with synthetic reins preserves high temperature. Thus, it takes more time until the hexagonal nuts are cooled down.

### DISCLOSURE OF INVENTION

The present invention has been accomplished in view of the above. In other words, the present invention provides a synthetic resin member having a metal female screw which has a high productivity without time and efforts.

There is provided a synthetic resin member comprising a screw formation portion comprising: a cylindrical metal portion having a first end and a second end, a female screw part being formed on the cylindrical portion; a release prevention portion formed at the first end; a flange portion formed at the second end, the flange portion having a first surface and a second surface opposite to the first surface; and a rotation prevention portion formed on the first surface. The screw formation portion is made of a metal. The synthetic resin member also comprises: a body portion perpendicularly extending to have a third end and a fourth end, the body portion having a screw engagement portion perpendicularly penetrating the body portion. The cylindrical metal portion is inserted into the screw engagement portion. The release prevention portion is caulked with the third end of the body portion. The rotation prevention portion is engaged with the synthetic resin body at or near the fourth end of the body portion.

The rotation prevention protrusion can be engaged with the synthetic resin body near the screw portion engagement hole.

The flange portion may have a shape other than a perfect circle, when view from the top.

The rotation prevention portion may be at least one claw formed by bending down a part of the flange portion.

The rotation prevention portion may a protrusion by deforming a part of the flange portion so as to protrude on the first surface.

The synthetic resin member may be a nip for rotation operation, and the female screw can be screw-engaged with a screw shaft formed on a rotation operation shaft.

There is also provided furniture comprising: a to-be-adjusted object fixed on an installment surface; and a screw bar for space adjustment. The screw bar has a right screw portion and a left screw portion. Two of the synthetic resin members are used and engaged with the right screw portion and the left screw portion, respectively. One of the synthetic resin member is fixed to the to-be-adjusted object. The other of the synthetic resin is fixed to the installment surface.

### BRIEF DESCRIPTION OF THE DRAWINGS

FIG. 1 illustrates a longitudinal cross section view of a nip for valve operation as an example of the synthetic resin member concerning Example 1 of the present invention.

FIG. 2 illustrates a bottom view of the nip for valve operation concerning Example 1.

FIG. 3 illustrates a plan view of the nip for valve operation concerning Example 1, in which the cap thereof is detached.

FIG. 4 illustrates a plan view of a disassembled view the nip for valve operation concerning Example 1, in which a part thereof is cut.

FIG. 5 illustrates a disassembled perspective view the nip for valve operation concerning Example 1, in which a part thereof is cut.

FIG. 6 illustrates a use condition of the synthetic resin member to adjust the height or level of the furniture or office automation devices as an example of the synthetic resin member concerning Example 2.

FIG. 7 illustrates a longitudinal cross section view of an upper synthetic resin member body of the synthetic resin member concerning Example 2 of the present invention.

FIG. 8 illustrates a bottom view of the upper synthetic resin member body of the synthetic resin member concerning Example 2.

FIG. 9 illustrates a plan view of the upper synthetic resin member body of the synthetic resin member concerning Example 2.

FIG. 10 illustrates a longitudinal cross section view of the upper synthetic resin member body of the synthetic resin member concerning Example 2.

FIG. 11 illustrates a plan view of the lower synthetic resin member body of the synthetic resin member concerning Example 2.

FIG. 12 illustrates a bottom view of the lower synthetic resin member body of the synthetic resin member concerning Example 2.

### EXAMPLE 1

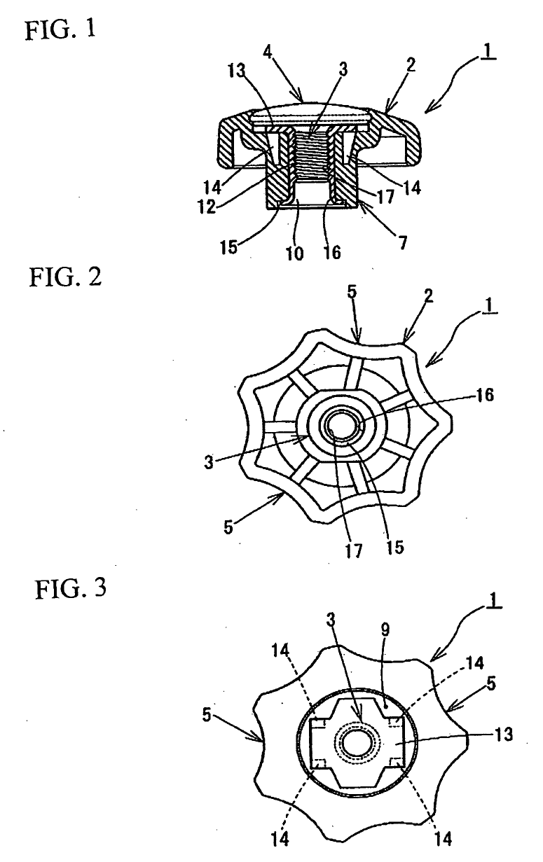

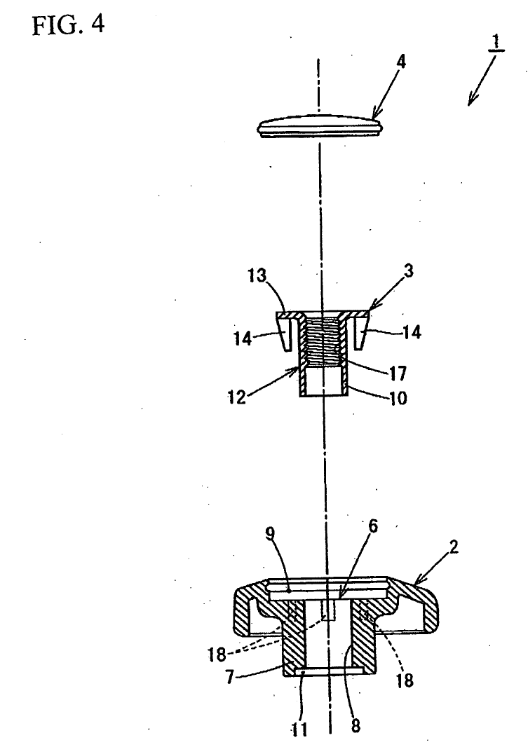

FIG. 1 illustrates a longitudinal cross section view of a nip for valve operation as an embodiment of a synthetic resin member having a metal female screw portion, in which it is used by being attached to an operation shaft of open/close valve (not illustrated in the drawings). FIG. 2 illustrates a bottom view of the nip for valve operation. FIG. 3 illustrates a plan view the nip for valve operation, in which the cap thereof is detached. FIG. 4 illustrates a plan view of a disassembled view the nip for valve operation, in which a part thereof is cut.

The nip 1 for valve operation has a body 2 made of a synthetic resin (i.e., a synthetic resin body), a screw formation portion 3 and cap 4 engaged with the body 2.

The body 2 has formed seven dimples 5 such that each draws a moderate arc on the outside of the body, and the upper portion of the body has swelled while the center thereof has a screw engagement portion 6 which is closed by cap 4.

The screw engagement portion 6 has a screw portion engagement hole 8 in such a way that it runs perpendicularly downward from the upper surface of the body 2 at the center of the cylindrical portion 7. A cavity 9 for engaging the cap, having a large diameter, is formed at the upper portion of the screw portion engagement hole 8. At the lower portion of the screw portion engagement hole 8, a space 11 is formed for housing the caulked portion of the to-be-caulked portion 10 that is formed on the screw formation portion 3, which is hereinafter described.

The screw formation portion 3 for engaging with the screw engagement portion 6 is disclosed in, e.g., JP Laid-open Patent Publication Nos. 4-34160, 5-118317, 9-196040, and 2006-183796. Also, the inventor of the present invention has previously proposed in his applications.

Therefore, the detailed explanation of the process is omitted, and general concept of the structure is described here.

The screw formation portion 3 is processed by e.g., a press method of a plate metal material, to form a flange portion 13 in a plate-like shape, which is protruded outward from one end of the cylindrical portion 12 (i.e., the upper portion in FIG. 4) and generally perpendicular to the central axis of the cylindrical portion 12. A female screw 17 is formed at the other end of the cylindrical portion 12 (i.e., the lower portion in FIG. 4) except for the to-be-caulked portion 10, which is used for caulking.

On the flange portion 13 in a plate-like shape, a part of the periphery portion thereof is folded down to form two claws 14 on each side, totaling four claws in such a way that they are opposed to each other at an angle of 180° about the center axis of the shank. The claws are directed to the perpendicular downward direction in the drawing. Other than the portion where the four claws 14 are formed, the flange portion 13 is formed in a plate shape.

By the four claws 14, the screw formation portion 13 is served as a rotation prevention portion of the screw formation portion 3.

The cylindrical portion 12 has formed the female screw 17, and the flange portion 13 and the to-be-caulked portion 10 are formed from one sheet of metal material. For example, the present inventor has proposed in Japanese Laid-open patent publication No. 11-241317 in which a rough shape is formed by drawing process of a press, and then the inside of the cylindrical portion 2 is scraped by e.g., tapping to form a female screw 17.

The cap 4 of the body 2 is detached to expose the screw member engagement hole 8. Then, the screw formation portion 3 as formed above is press-fitted into the screw portion engagement portion 8 from the side of the space 9 for cap engagement. Thereby, the to-be-caulked portion 10, being formed in a thin, cylindrical shape, is protruded into the space 11 for housing the caulking portion.

By press-fitting, the four claws formed on the outer periphery of the flange portion 13 is inserted into the body near the bottom surface of the screw portion engagement portion 8, that is formed in the space 9 for cap engagement. Therefore, the screw formation portion 3 is prevented from rotating with respect to the body 2.

Then, the to-be-caulked portion 10, being formed in a thin, cylindrical shape such that it is protruded into the space 11 for housing the caulking portion while penetrating the screw portion engagement portion 8, is subject to e.g., a press process so as to radially extend into the space 11 for housing the caulking portion. The screw formation portion 3 is firmly fixed to the screw portion engagement hole 8 by the caulked portion 15 and the flange portion 13 so as to form a metal female screw 17 on the nip for valve operation made of synthetic resin.

Then, the cap 4 is attached to the space 9 for cap engagement in order to cover the upper portion of the flange portion 13 to provide the nip 1 for valve operation.

The screw formation portion 3, attached to the screw portion engagement portion 8, is radially extended as to the to-be-caulked portion 10 by means of a process such as pressing. The caulked portion 15 as extended has a slope surface 16 in a shape of bell mouse or trumpet as illustrated in FIG. 1. When the nip 1 for valve operation is installed by the slope surface 16, the slope surface 16 in a shape of bell mouse or trumpet directs the end of the valve open/close operation shaft toward the female screw 17. Thus, the nip 1 for valve operation can be easily and accurately attached at the position.

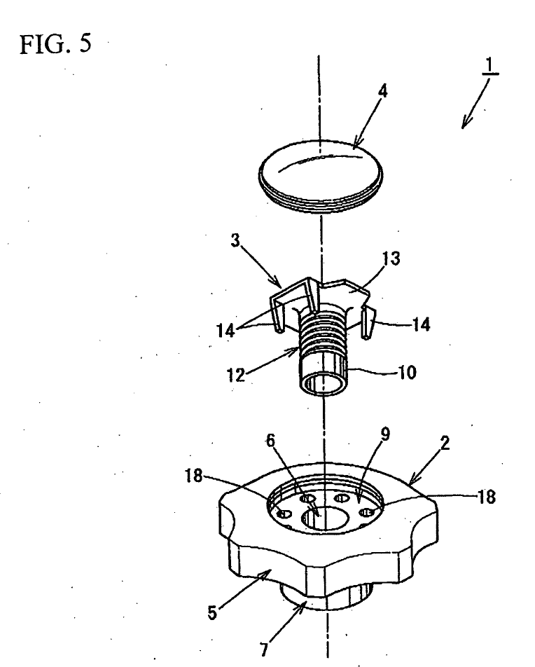

In the embodiment, shank portion 12 forming the female screw 17, the flange portion 13 and the to-be-caulked portion 10 were roughly formed by drawing by press from one sheet of a metal plate, and then, the female screw 17 is formed inside the shank portion 12 by tapping. However, the present invention is not limited thereto. For example, as illustrated in FIG. 5, a shank portion 12 is formed by a cylindrical portion made of a thin metal plate, and the inside of the shank portion 12 made of thin metal is applied to a tap, and the outside thereof is applied to a gear. In such a sandwiching condition, the shank portion 12 made of thin metal is deformed in to a screw form to form a screw potion 17 except for the inside portion to form the to-be-caulked portion 10, which is then welded to a plate-like flange portion 13 having formed claws 14.

Note that the direction of the female screw does not matter in the embodiment.

In addition, in the embodiment, the claws 14 formed on the flange portion 13 are press-fitted in the body 2. As illustrated in the dotted lines in FIG. 4 and solid lines in FIG. 5, several holes 18 for engaging claws can be in advance formed at the peripheries of the screw portion engagement portion 8, into which the claws 14 are inserted to avoid the rotation of the screw formation portion 3.

### EXAMPLE 2

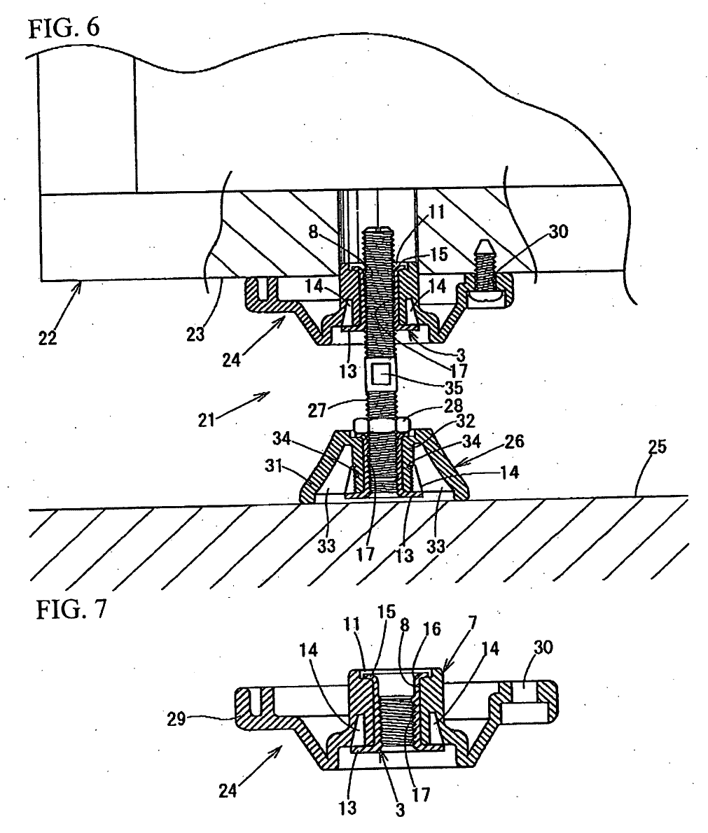

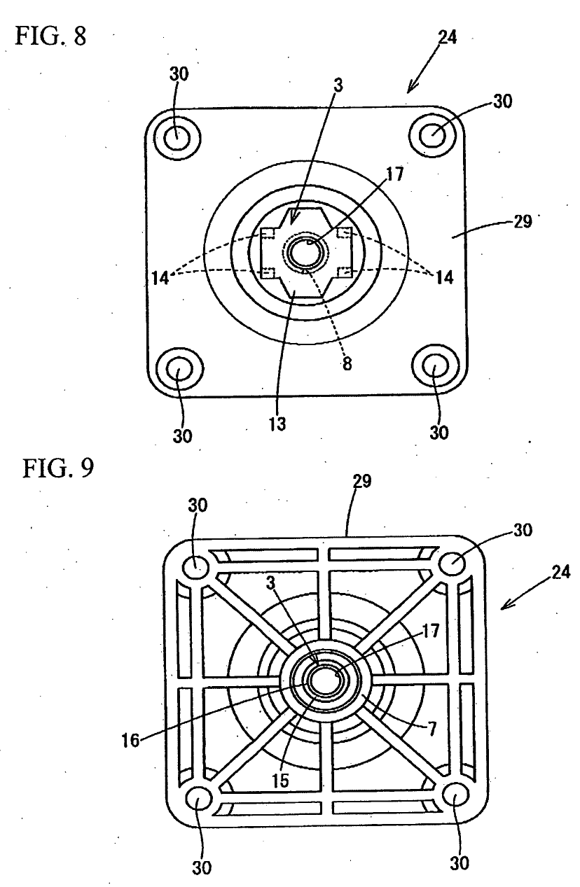

FIGS. 6 to 12 illustrate a synthetic resin member 21 having a metal female screw for adjusting the height or level of furniture or office automation devices (to-be-adjusted body). FIGS. 6 to 12 illustrates cross sectional views of use conditions.

The synthetic resin member 21 of the embodiment has an upper synthetic resin body 24, to be attached on a lower surface portion of furniture or office automation devices, a lower synthetic resin body 26 contacting the installment surface 25, screw bar 27 for space adjustment and lock nut 28 which are screw-engaged with both the upper and lower synthetic resin bodies 24, 25.

The upper synthetic resin body 24, as illustrated in FIGS. 6 to 9, forms attachment hole 30 at the hour corners of the square base 29, the attachment hole 30 attaching the upper synthetic resin body 24 to the lower surface portion 23 of furniture or office automation devices 22. In the center of the base 29, the screw portion engagement hole 8 penetrates, into which the screw formation portion 3 is attached in the same manner as Example 1. The explanation about the attachment is omitted but the same reference numbers are used as Example 1.

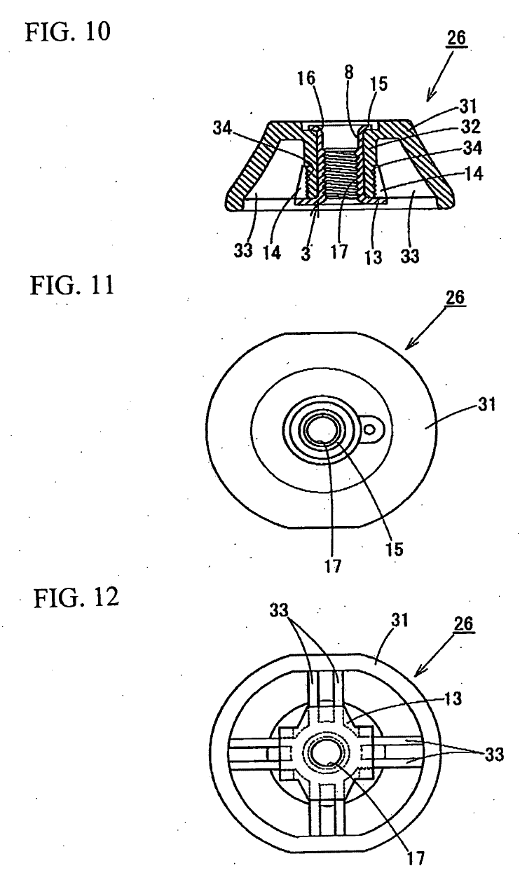

As illustrated in FIGS. 10 to 12, the lower synthetic resin body 26 is shaped into a circular truncated cone form such that its lower surface serves as a contact surface. The body 31 thereof has an internal space at its central portion to run perpendicularly to form a screw portion engagement portion 8 at the cylindrical shank portion 32. To the screw portion engagement portion 8, a screw formation portion 3 is engaged.

Here, since the screw portion engagement portion 8 has formed the cylindrical shank portion 32 extending perpendicularly, the screw formation portion 3 is prevented from rotation of the screw portion engagement portion 8 as follows:

Namely, the cylindrical shank portion 32, extending perpendicular at the central portion of the internal space of the body 31 shaped into a circular truncated cone form, is supported by a pair of ribs 33, crossing each other. The gear 34 is formed at the side surface of the cylindrical shank portion 32 of the claw 14 formed at the flange portion 13 of the screw portion 3. The gear 34 is inserted into the outside surface of the cylindrical shank portion 32, while the claw 14 contacts the rib 33 so as to prevent the rotation of the screw formation portion.

This embodiment is a synthetic resin member 21 having a metal female screw portion which is used for adjusting the height or level of the furniture or office automation devices (to-be-adjusted be-adjusted portion). Thus, the screw bar 27 for space adjustment has opposite screw directions between the upper half of the center and the lower half of the center.

Therefore, the female screw 17 of the screw formation portion 3 for engaging with the screw portion engagement portion 8 of the upper synthetic resin body 24 is different in the direction of the screw from the screw formation portion 3 for engaging with the screw portion engagement portion 8 of the lower synthetic resin body 24.

The reference number 35 in FIG. 6 is a tool attachment portion formed by scraping a part of the screw bar 27 for space adjustment in order to attaching a tool for rotating the screw bar 27 for space adjustment.

When the synthetic resin member 21 having the metal female screw of the embodiment is used for adjusting the height or level of the furniture or office automation devices (to-be-adjusted portion) 22, the lock nut 28 is first loosed.

Then, to the tool attachment portion 35 of the screw bar 27 for space adjustment, a tool such as spanner is inserted to rotate the screw bar 27 for space adjustment in order to adjust the height or level of the furniture or office automation devices (to-be-adjusted portion) 22.

At that time, since the female screw 17 of the upper synthetic resin body 24 and the lower synthetic resin body 26 are made of metal, even if the furniture or office automation devices (to-be-adjusted portion) 22 are heavy, the screw head is not deformed, allowing easy and reparable adjustment.

When the height or level of the furniture or office automation devices (to-be-adjusted portion) 22 is finished, the screw bar 27 for space adjustment is again fixed by the lock nut 28, completing the adjustment operation.

In the embodiments explained above, the rotation of the screw formation portion 3 is prevented by the claws 14, but the present invention is not limited thereto. For example, a projection by deforming a part of the periphery of the flange partition from the outside to the inside can be used in this purpose. Alternatively, the flange portion 13 and the shank portion 12 near the flange portion are formed as a polygon (e.g., hexagon, heptagon, or octagon), or eclipse or oval shape except for a circle when viewed in the plane view, and the area to house these portions is shaped into a convex corresponding to the projection, the flange 13 and the shank portion 12 near the flange portion. Also, the rotation of the screw formation portion 3 is prevented by the engagement with the convex formed in the polygon, or eclipse or oval shape except for a circle.

The symbols used in the drawings are summarized below:

1: synthetic resin member

2: body

3: screw formation portion

8: screw portion engagement hole

10: to-be-caulked portion

12: cylindrical portion

13: flange portion

14: claw

17: female screw

21: synthetic resin member

31: body

What is claimed is:

1. A synthetic resin member, comprising:
a screw formation portion wherein the screw formation portion is made of a metal, the screw formation portion comprising:
a cylindrical metal portion having a first end and a second end;
a female screw part being formed on the cylindrical portion;
a release prevention portion formed at the first end;
a flange portion formed at the second end, the flange portion having a first surface and a second surface opposite to the first surface; and
a rotation prevention portion formed on the first surface, and a synthetic resin body comprising:
a body portion perpendicularly extending, the body portion having a third end and a fourth end,
a screw engagement portion formed on the body portion, the screw engagement portion perpendicularly penetrating the body portion;
wherein the cylindrical metal portion is inserted into the screw engagement portion, wherein the release prevention portion is caulked with the third end of the body portion; and wherein the rotation prevention portion is engaged with the synthetic resin body at or near the fourth end of the body portion.

2. A synthetic resin member according to claim 1, wherein the rotation prevention protion is engaged with the synthetic resin body near the screw portion engagement portion.

3. A synthetic resin member according to claim 1, wherein the flange portion has a shape other than a perfect circle, when viewed from the top.

4. A synthetic resin member according to claim 1, wherein the rotation prevention portion is at least one claw formed by bending down a part of the flange portion.

5. A synthetic resin member according to claim 1, wherein the rotation prevention portion is a protrusion by deforming a part of the flange portion so as to protrude on the first surface.

6. A synthetic resin member according to claim 1, wherein the synthetic resin member is a nip for rotation operation, wherein the female screw is screw-engaged with a screw shaft formed on a rotation operation shaft.

7. A furniture comprising:
a to-be-adjusted object fixed on an installment surface; and
a screw bar for space adjustment, the screw bar having a right screw portion and a left screw portion;
wherein two of the synthetic resin members according to claim 1 are engaged with the right screw portion and the left screw portion, respectively, one of the synthetic resin members is fixed to the to-be-adjusted object, wherein the other of the synthetic resin member is fixed to the installment surface.
